(19) United States
(12) Patent Application Publication
(10) Pub. No.: US 2004/0268009 A1
(43) Pub. Date: Dec. 30, 2004

(54) Transceiving network controller and method for controlling buffer memory allocation and data flow

(75) Inventors: Jong-Hoon Shin, Suwon-city (KR); Myeong-Jin Lee, Anyang-city (KR); Min-Joung Lee, Jangan-gu (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 10/791,511

(22) Filed: Mar. 2, 2004

(30) Foreign Application Priority Data
Jun. 11, 2003 (KR) 2003-37462

(51) Int. Cl. G06F 13/00

(52) U.S. Cl. 710/310; 710/52

(57) ABSTRACT

A transceiving network controller that controls memory allocation of a buffer memory according to data flow and a method for controlling memory allocation and data flow. The transceiving network controller comprises a system bus, a buffer memory including a transmitting area capable of flexible memory allocation according to transmitted data flow and a receiving area capable of flexible memory allocation according to received data flow, the buffer memory for storing and outputting transmitted data in response to at least one transmitting address signal and for storing and outputting received data in response to at least one receiving address signal, a flow control unit for generating and outputting threshold control signals for increasing the memory allocation of the transmitting area when a transmission execution signal becomes active and for increasing the memory allocation of the receiving area when a reception execution signal becomes active, a transmitting controller for generating a plurality of transmitting address signals, and a receiving controller for generating a plurality of receiving address signals.

### BACKGROUND OF THE INVENTION

This application claims the priority of Korean Patent Application No. 2003-37462, filed on Jun. 11, 2003, in the Korean Intellectual Property Office, the disclosure of which is incorporated herein in its entirety by reference.

1. Technical Field

The present disclosure relates to a data communication device, and more particularly, to a transceiving network controller that controls routes of data communication and memory allocation according to data flow and a method for controlling memory allocation and data flow.

2. Discussion of the Related Art

A data communication device, for example, an ethernet, a universal serial bus (USB), direct memory access (DMA), an asynchronous transfer mode-segmentation and reassembly sublayer (ATM-SAR), may be a part of a system such as a computer or a mobile terminal and regulate data communications between the system and internal or external media connected to the system. However, data overflow or underflow in data communications between the system and the media may occur due to imbalance of mutual data processing speed and arbitration within the system. A network controller that controls data flow in the data communication device may be provided to prevent data overflow or underflow. That is, the data overflow or underflow may be prevented by using a buffer memory or a first-in first-out (FIFO) memory included in the predetermined network controller of the data communication device. Furthermore, general DMA or exclusive DMA may be used in order to reduce a computational load of a control processing unit (CPU) or a micro control unit (MCU) and to regulate an interface included in the network controller. The network controller of the data communication device may have independent transmitting and receiving memories, and control data flow over an independent transceiving route via the memories.

FIG. 1 is a block diagram of a conventional transceiving network controller.

Referring to FIG. 1, the conventional transceiving network controller includes independent transmitting and receiving memories 110 and 130, and controls data flow over an independent transceiving route via a transmitting controller 120 and a receiving controller 140. The network controller is a media access control (MAC) layer controlling data flow between a higher layer such as the MCU and a lower layer such as a physical layer. That is, the transmitting controller 120 receives data (SYSTD) to be transmitted at a system bus (SYSBUS) and transmits data (PHYTD) to the physical layer via the transmitting memory 110 by controlling data flows. In addition, the receiving controller 140 receives data (PHYRD) to be received at the physical layer and transmits data (SYSRD) to the SYSBUS via the receiving memory 130 by controlling data flow. The control of data flow may be performed using a half or full duplex method.

The transmitting memory 110 and the receiving memory 130 included in the conventional transceiving network controller in FIG. 1 may be a FIFO type in case of a MAC or a DMA buffer in case of exclusive DMA. The two memories prevent data loss that may occur in communications between a system and other media, make temporary storage easy, and secure stable transceiving data processing.

However, regardless of the half or full duplex method, data communications is often performed in an asymmetrical way as in an asymmetric digital subscriber line (ADSL). Although a data communication device supports the full duplex method, only one of data transmission and reception is performed rather than simultaneously executing both of them for a certain period. Therefore, if one of data transmission and reception is performed, a buffer or the FIFO that is a form of memory included in the conventional transceiving network controller, is separated for transmission and reception in hardware, and thus utilization of hardware is lowered due to unused memory storage capacity. In addition, a separated transceiving memory has relatively higher possibility of causing a data overflow or underflow, and system overhead is inevitably large to compensate for these features.

### SUMMARY OF THE INVENTION

According to an embodiment of the present invention, a transceiving network controller controls a buffer memory to flexibly allocate memory according to data flow and regulates data communications between a system and media connected to the system.

A transceiving network, according to an embodiment of the present invention, includes a system bus, a buffer memory, a flow control unit, a transmitting controller, and a receiving controller. The buffer memory includes a transmitting area capable of flexible memory allocation according to transmitted data flow and a receiving area capable of flexible memory allocation according to received data flow. The buffer memory stores and outputs transmitted data in response to at least one transmitting address signal and stores and outputs received data in response to at least one receiving address signals.

The flow control unit generates and outputs threshold control signals to increase the memory allocation of the transmitting area when a transmission execution signal becomes active and of the receiving area when a reception execution signal becomes active.

The transmitting controller generates a plurality of transmitting address signals having a maximum address capable of being changed by the threshold control signals, outputs at least one transmitting write address signal of the plurality of transmitting address signals with data received from the system bus, and outputs transmitted data output from the buffer memory to a lower layer, the transmitted data being output from the buffer memory in response to at least one transmitting read address signal of the plurality of transmitting address signals, and in response to the transmission execution signal becoming active upon receipt of the data from the system bus.

The receiving controller generates a plurality of receiving address signals having a maximum address capable of being changed by the threshold control signals, outputs at least one receiving write address signal of the plurality of receiving address signals with data received from the lower layer, and outputs received data output from the buffer memory to the system bus, the received data being output from the buffer memory in response to at least one receiving read address signal of the plurality of receiving address signals, and in response to the reception execution signal becoming active upon receipt of the data from the lower layer.

The flow control unit may generate the threshold control signals for maintaining the memory allocation of the transmitting and receiving areas when the transmission and reception execution signals become active simultaneously. In addition, the flow control unit may generate the threshold control signals to equalize the memory allocation of the transmitting and receiving areas in an early stage when power is on. Moreover, the flow control unit may generate the threshold control signals for maintaining the memory allocation of the transmitting and receiving areas at a predetermined threshold in accordance with a predetermined setting, for example set by a user.

The transmitted and received data may be transmitted using a full or half duplex method.

According to an embodiment of the present invention, a method for controlling buffer memory allocation and data flow, wherein the buffer memory includes a transmitting area and a receiving area capable of flexible memory allocation according to transmitted and received data flow, respectively, comprises storing and outputting transmitted data in and from the buffer memory in response to at least one transmitting address signal, storing and outputting received data in and from the buffer memory in response to at least one receiving address signal, generating and outputting threshold control signals for increasing memory allocation of the transmitting area when a transmission execution signal becomes active and for increasing memory allocation of the receiving area when the reception execution signal becomes active, generating a plurality of transmitting address signals having a maximum address capable of being changed by the threshold control signals, outputting at least one transmitting write address signal of the plurality of transmitting address signals with data received from a system bus, outputting transmitted data output from the buffer memory to a lower layer, the transmitted data being output from the buffer memory in response to at least one transmitting read address signal of the plurality of transmitting address signals, and in response to the transmission execution signal becoming active upon receipt of the data received from the system bus, generating a plurality of receiving address signals having a maximum address capable of being changed by the threshold control signals, outputting at least one receiving write address signal of the plurality of the receiving address signals with the data received from the lower layer, and outputting received data output from the buffer memory to the system bus, the received data being output from the buffer memory in response to at least one receiving read address signal of the plurality of receiving address signals, and in response to the reception execution signal becoming active upon receipt of the data received from the lower layer.

The threshold control signals may maintain the memory allocation of the transmitting and receiving areas when the transmission and reception execution signals become active simultaneously. In addition, the threshold control signals may equalize the memory allocation of the transmitting and receiving areas in an early stage when power is turned on. Moreover, the threshold control signals may maintain the memory allocation of the transmitting and receiving areas at a predetermined threshold in accordance with a predetermined user setting.

The transmitted and received data may be transmitted using a full or half duplex method.

A transceiving network controller, according to an embodiment of the present invention, comprises a system bus, a buffer memory including a transmitting area capable of flexible memory allocation according to transmitted data flow and a receiving area capable of flexible memory allocation according to received data flow, the buffer memory for storing and outputting transmitted data in response to at least one transmitting address signal and for storing and outputting received data in response to at least one receiving address signal, a flow control unit for generating and outputting threshold control signals for increasing the memory allocation of the transmitting area when a transmission execution signal becomes active and for increasing the memory allocation of the receiving area when a reception execution signal becomes active, a transmitting controller for generating a plurality of transmitting address signals, and a receiving controller for generating a plurality of receiving address signals.

Each of the plurality of transmitting address signals may include a maximum address capable of being changed by the threshold control signals. Each of the plurality of receiving address signals may include a maximum address capable of being changed by the threshold control signals. The transmission execution signal may become active when the transmitting controller receives transmitted data from the system bus. The reception execution signal may become active when the receiving controller receives received data from a lower layer.

A method for controlling buffer memory allocation and data flow, wherein the buffer memory includes a transmitting area and a receiving area capable of flexible memory allocation, in accordance with an embodiment of the present invention, comprises storing and outputting transmitted data in and from the buffer memory in response to at least one transmitting address signal, storing and outputting received data in and from the buffer memory in response to at least one receiving address signal, generating and outputting threshold control signals for increasing memory allocation of the transmitting area when a transmission execution signal becomes active and for increasing memory allocation of the receiving area when a reception execution signal becomes active, generating a plurality of transmitting address signals having a maximum address capable of being changed by the threshold control signals, and generating a plurality of receiving address signals having a maximum address capable of being changed by the threshold control signals.

### BRIEF DESCRIPTION OF THE DRAWINGS

Preferred embodiments of the present invention can be understood in more detail from the following descriptions taken in conjunction with the accompanying drawings in which:

FIG. 1 is a block diagram of a conventional transceiving network controller;

FIG. 2 is a block diagram of a transceiving network controller according to an embodiment of the present invention;

FIG. 3 is a schematic drawing of a finite state machine (FSM) of a flow control unit of FIG. 2; and

FIG. 4 is a schematic drawing to explain an allocation state of a buffer memory of FIG. 2 according to transceiving flows of FIG. 3.

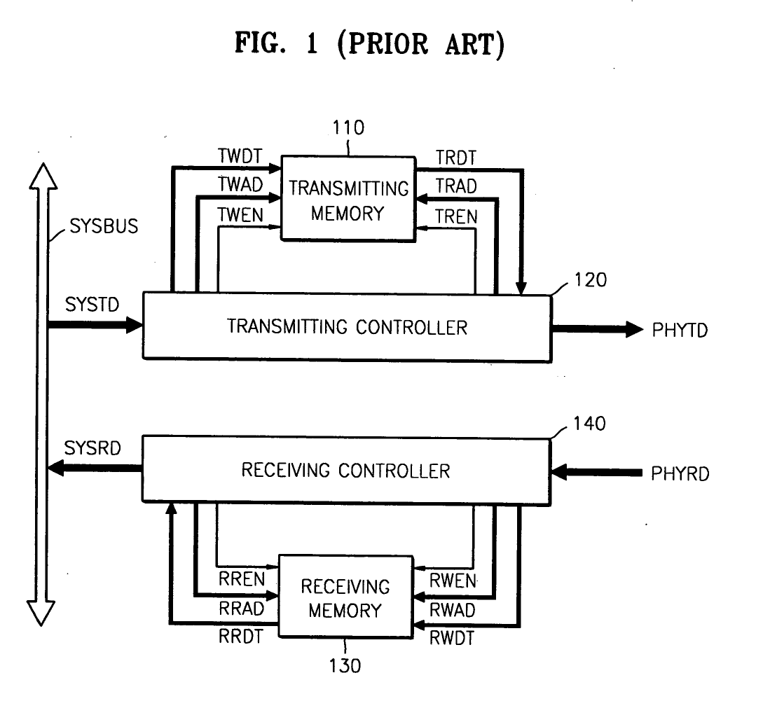

### DETAILED DESCRIPTION OF THE PREFERRED EMBODIMENTS

Preferred embodiments of the present invention will now be described more fully hereinafter below with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

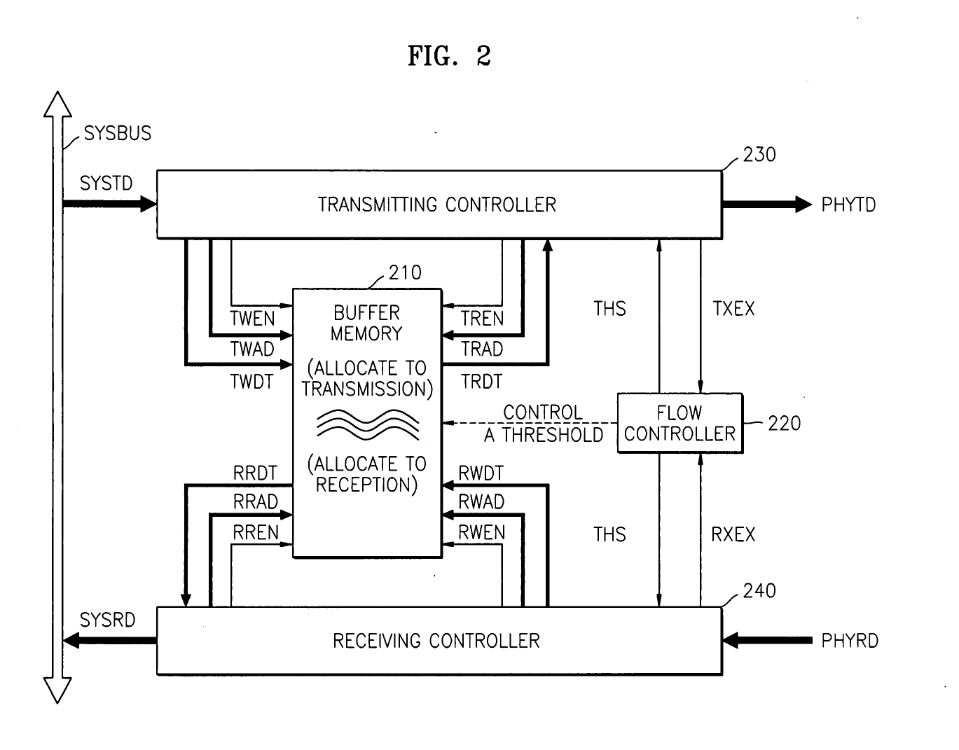

FIG. 2 is a block diagram of a transceiving network controller according to an embodiment of the present invention.

Referring to FIG. 2, the transceiving network controller includes a system bus (SYSBUS), a buffer memory 210, a flow control unit 220, a transmitting controller 230, and a receiving controller 240.

The buffer memory 210 includes transmitting and receiving areas having the flexible memory allocation according to transmitted and received data flow, respectively, and stores and outputs transmitted and received data based on transmitting and receiving address signals, respectively. Examples of transmitting address signals include TWEN, TWAD, TREN, and TRAD, and examples of the receiving address signals include RWEN, RWAD, RREN, and RRAD. The transmitted and received data are transmitted using a half or full duplex method. While in the full duplex method, data transmission and reception are simultaneously performed, in the half duplex method, data transmission and reception are separately performed in a transceiving network structure.

The transmitted data are categorized into three types, that is, SYSTD data received from the system bus, TWDT data written from the transmitting controller 230 to the buffer memory 210 in order to be temporarily stored in the buffer memory 210, and TRDT data read from the buffer memory 210 to the transmitting controller 230 in order to be finally transmitted to a lower layer such as a physical layer. TWEN and TWAD signals denote transmitting write enable signals and transmitting write address signals, respectively. TREN and TRAD signals denote transmitting read enable signals and transmitting read address signals, respectively.

Similarly, the received data are categorized into three types, that is, PHYRD data received from a lower layer such as the physical layer and RWDT data written from the receiving controller 240 to the buffer memory 210 in order to be temporarily stored in the buffer memory 210, and RRDT data read from the buffer memory 210 to be transmitted to the receiving controller 240 and finally received by the SYSBUS. RWEN and RWAD signals denote receiving write enable signals and receiving write address signals, respectively. RREN and RRAD signals denote receiving read enable signals and receiving read address signals, respectively.

The flow control unit 220 generates and outputs threshold control signals (THS) to increase memory allocation of a transmitting area when a transmission execution (TXEX) signal becomes active and of a receiving area signal when a reception execution (RXEX) signal becomes active. That is, the flow control unit 220 controls a threshold for the memory allocation of the transmitting and receiving areas in the buffer memory 210 by outputting the THS to the transmitting controller 230 and the receiving controller 240.

The transmitting controller 230 generates the transmitting address signals such as the TWEN, TWAD, TREN, and TRAD signals having the maximum address flexibly changed by the THS, and outputs transmitting write address signals TWAD of the transmitting address signals with the transmitted data SYSTD received from the system bus SYSBUS. The transmitting controller 230 outputs the TRDT data to a lower layer when the TRDT data is output and received from the buffer memory 210. The TRDT data is output from the buffer memory 210 in response to the TRAD signal of the transmitting address signals received from the transmitting controller 230, and in response to the TXEX signal in an active state due to receipt of the SYSTD data by the transmitting controller 230. For instance, the TXEX signal is output in a state of logic low or logic high and becomes active in a state of logic high when the SYSTD data is received by the transmitting controller 230. Transmitted data (PHYTD) that is output from the transmitting controller 230 to a lower layer such as a physical layer may be packet data according to a media access control (MAC) protocol.

The receiving controller 240 generates the receiving address signals such as the RWEN, RWAD, RREN, and RRAD signals having the maximum addresses flexibly changed by the THS and outputs receiving write address signals RWAD of the receiving address signals with the received data PHYRD received from a lower layer. The receiving controller 240 outputs the RRDT data output and received from the buffer memory 210 to the system bus. The RRDT data is output from the buffer memory 210 in response to the RRAD signal of the receiving address signals received from the receving controller 240, and in response to the RXEX signal in an active state due to receipt of the PHYRD data by the receiving controller 240.

For instance, the RXEX signal is output in a state of logic low or logic high and becomes active in a state of logic high, when the PHYRD data is received by the receiving controller 240. SYSRD data output from the receiving controller 240 is sent to a higher layer, for example, the MCU or CPU, such that the SYSRD data may be restored to the original data before data packeting in which the PHYRD data received at a lower layer such as a physical layer is the packet data according to the MAC protocol.

Operations of the flow control unit 220 shown in FIG. 2 will be explained in more detail below.

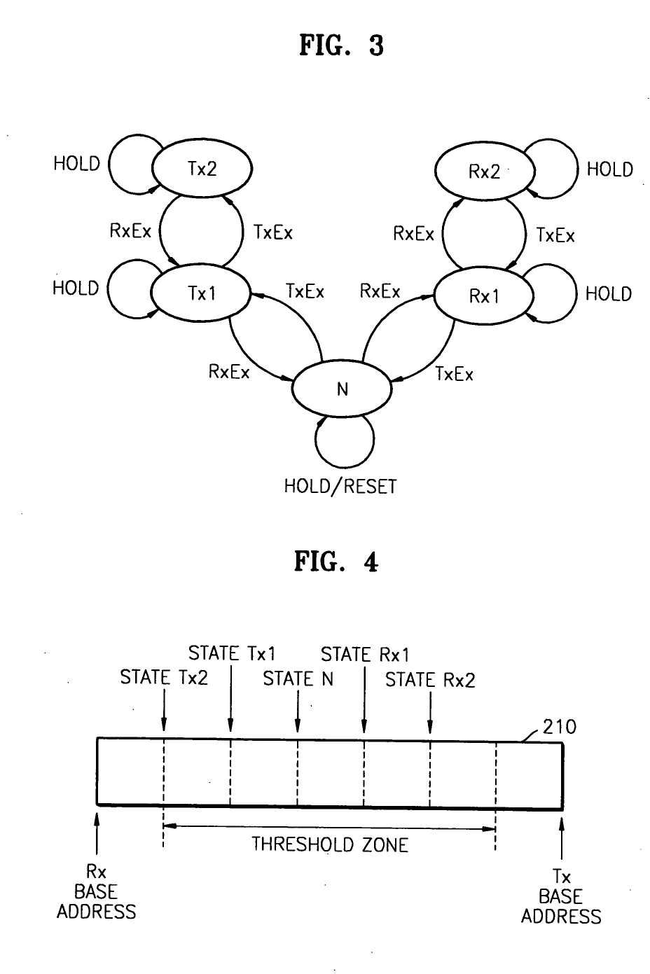

FIG. 3 is a schematic drawing of a finite state machine (FSM) of the flow control unit 220 shown in FIG. 2 and FIG. 4 is a schematic drawing for explaining an allocation state of a buffer memory of FIG. 2 according to transceiving flows of FIG. 3.

Referring to FIGS. 3 and 4, in accordance with an amount of data transmission and reception, the flow control unit 220 generates the THS for changing a threshold (dotted lines in FIG. 4) representing an amount of memory allocation of transmitting and receiving areas. The threshold states are represented by N, TX1, TX2, RX1, and RX2, where N is neutral and represents equal memory allocation in transmitting and receiving areas. TX1 and TX2 and RX1 and RX2 represent increased memory allocation for transmitting and receiving areas, respectively. After checking whether the TXEX and RXEX signals are in the active state, the flow control unit 220 generates the THS in order to maintain or change the threshold states among N, TX1, TX2, RX1, and RX2.

For instance, in an early stage, when power is turned on, the flow control unit 220 generates a THS equalizing the memory allocation in the transmitting and receiving areas. This THS is a signal that directs a reset and corresponds to a neutral state N in FIG. 3. Therefore, the threshold of the buffer memory 210 corresponds to the neutral state N.

When the TXEX signal becomes active, the flow control unit 220 generates and outputs a THS to increase the memory allocation of the transmitting area. In this case, the THS is a signal output to the transmitting controller 230 instructing an increase of the memory allocation of the transmitting area. Therefore, if the previous state is the neutral state N in FIG. 3, the THS instructs a change to threshold state TX1 and the threshold of the buffer memory 210 corresponds to the state TX1 in FIG. 4. When an address corresponding to the state TX1 becomes the threshold, an address of the buffer memory 210 corresponding to the state TX1 becomes the maximum address used for transmission. As shown in FIG. 4, a length between a minimum address (TX BASE ADDRESS) used for transmission and the state TX1 is longer than that between a minimum address (RX BASE ADDRESS) for reception and the state TX1. Depending on the initial threshold state, if a THS increasing the memory allocation of the transmitting area is generated, changes of threshold state will occur from RX2 to RX1, RX1 to N, N to TX1, or TX1 to TX2.

When the RXEX signal becomes active, the flow control unit 220 generates and outputs a THS to increase the memory allocation of the receiving area. In this case, the THS is a signal output to the receiving controller 240 instructing the increase of the memory allocation of the receiving area. For example, if the previous state is the neutral state N in FIG. 3, the THS instructs a change to the state RX1 and the threshold of the buffer memory 210 corresponds to the state RX1 in FIG. 4. In the event that an address corresponding to the state of RX1 becomes the threshold, the address of the buffer memory 210 corresponding to RX1 becomes the maximum address used for reception. Therefore, as shown in FIG. 4, a length between the minimum address (TX BASE ADDRESS) used for transmission and the state RX1 is less than that between the minimum address (RX BASE ADDRESS) for reception and the state RX1. Depending on the initial threshold state, if a THS increasing the allocated amount of the receiving area is generated, changes of threshold state will occur from TX2 to TX1, TX1 to N, N to RX1, and RX1 to RX2.

Referring to FIG. 3, the flow control unit 220 generates a THS to maintain the memory allocation of the transmitting and receiving areas when the TXEX and RXEX signals become active at the same time. Furthermore, if necessary, a user may asymmetrically use the buffer memory 210, and in this case, set a predetermined fixing threshold using predetermined software or hardware. According to the user's setting, the flow control unit 220 can generate a THS to hold the allocated amount of the transmitting and receiving areas at the predetermined fixing threshold.

As described above, in accordance with transceiving data flows, the flow control unit 220 controls the memory allocation of the transmitting and receiving areas used for transmission and reception in the buffer memory 210. This type of transceiving network controller may be used for a data communication device such as an ethernet, a universal serial bus (USB), direct memory access (DMA), and an asynchronous transfer mode-segmentation and reassembly sub-layer (ATM-SAR). In addition, if the buffer memory 210 is maintained to the state N in FIG. 4 by a user, the buffer memory 210 may be the same as the existing memory independently used for transmission and reception.

As a result, the transceiving network controller, according to an embodiment of the present invention, regulates data communications between a system and other media by controlling the buffer memory so that the memory allocation of transmitting and receiving areas can be changed according to the transmitted and received data. Therefore, the buffer memory can be effectively used, the occurrence of overflow or underflow during data communications is reduced, and accordingly the use of the system can be optimized.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A transceiving network controller comprising:
a system bus;
a buffer memory including a transmitting area capable of flexible memory allocation according to transmitted data flow and a receiving area capable of flexible memory allocation according to received data flow, the buffer memory for storing and outputting transmitted data in response to at least one transmitting address signal and for storing and outputting received data in response to at least one receiving address signal;
a flow control unit for generating and outputting threshold control signals for increasing the memory allocation of the transmitting area when a transmission execution signal becomes active and for increasing the memory allocation of the receiving area when a reception execution signal becomes active;
a transmitting controller for generating a plurality of transmitting address signals having a maximum address capable of being changed by the threshold control signals, for outputting at least one transmitting write address signal of the plurality of transmitting address signals with data received from the system bus, and for outputting transmitted data output from the buffer memory to a lower layer, the transmitted data being output from the buffer memory in response to at least one transmitting read address signal of the plurality transmitting address signals, and in response to the transmission execution signal becoming active upon receipt of the data received from the system bus; and
a receiving controller for generating a plurality of receiving address signals having a maximum address capable of being changed by the threshold control signals, for outputting at least one receiving write address signal of the plurality of receiving address signals with data received from the lower layer, and for outputting received data output from the buffer memory to the system bus, the received data being output from the buffer memory in response to at least one receiving read address signal of the plurality of receiving address signals, and in response to the reception execution signal becoming active upon receipt of the data received from the lower layer.

2. The transceiving network controller of claim 1, wherein the flow control unit generates a threshold control signal for maintaining the memory allocation of the transmitting area and the receiving area when the transmission execution signal and the reception execution signal become active simultaneously.

3. The transceiving network controller of claim 1, wherein the flow control unit generates a threshold control signal for equalizing the memory allocation of the transmitting area and the receiving area.

4. The transceiving network controller of claim 1, wherein the flow control unit generates a threshold control signal for maintaining the memory allocation of the transmitting area and the receiving area at a predetermined threshold in accordance with a predetermined setting.

5. The transceiving network controller of claim 1, wherein the transmitted data and the received data are transmitted using a full duplex method.

6. The transceiving network controller of claim 1, wherein the transmitted data and the received data are transmitted using a half duplex method.

7. A method for controlling buffer memory allocation and data flow, the buffer memory including a transmitting area and a receiving area capable of flexible memory allocation according to transmitted data flow and received data flow, respectively, the method comprising:
storing and outputting transmitted data in and from the buffer memory in response to at least one transmitting address signal;
storing and outputting received data in and from the buffer memory in response to at least one receiving address signal;
generating and outputting threshold control signals for increasing memory allocation of the transmitting area when a transmission execution signal becomes active and for increasing memory allocation of the receiving area when a reception execution signal becomes active;
generating a plurality of transmitting address signals having a maximum address capable of being changed by the threshold control signals;
outputting at least one transmitting write address signal of the plurality of transmitting address signals with data received from a system bus;
outputting transmitted data output from the buffer memory to a lower layer, the transmitted data being output from the buffer memory in response to at least one transmitting read address signal of the plurality of transmitting address signals, and in response to the transmission execution signal becoming active state upon receipt of the data received from the system bus;
generating a plurality of receiving address signals having a maximum address capable of being changed by the threshold control signals;
outputting at least one receiving write address signal of the plurality of receiving address signals with data received from the lower layer; and
outputting received data output from the buffer memory to the system bus, the received data being output from the buffer memory in response to at least one receiving read address signal of the plurality of receiving address signals, and in response to the reception execution signal becoming active upon receipt of the data received from the lower layer.

8. The method of claim 7, wherein the threshold control signals maintain the memory allocation of the transmitting area and the receiving area when the transmission execution signal and the reception execution signal become active simultaneously.

9. The method of claim 7, wherein the threshold control signals equalize the memory allocation of the transmitting area and the receiving area when power is turned on.

10. The method of claim 7, wherein the threshold control signals maintain the memory allocation of the transmitting area and the receiving area at a predetermined threshold in accordance with a predetermined setting.

11. The method of claim 7, wherein the transmitted data and the received data are transmitted using a full duplex method.

12. The method of claim 7, wherein the transmitted data and the received data are transmitted using a half duplex method.

13. A transceiving network controller comprising:
a system bus;
a buffer memory including a transmitting area capable of flexible memory allocation according to transmitted data flow and a receiving area capable of flexible memory allocation according to received data flow, the buffer memory for storing and outputting transmitted data in response to at least one transmitting address signal and for storing and outputting received data in response to at least one receiving address signal;
a flow control unit for generating and outputting threshold control signals for increasing the memory allocation of the transmitting area when a transmission execution signal becomes active and for increasing the memory allocation of the receiving area when a reception execution signal becomes active;
a transmitting controller for generating a plurality of transmitting address signals; and
a receiving controller for generating a plurality of receiving address signals.

14. The transceiving network controller of claim 13, wherein each of the plurality of transmitting address signals includes a maximum address capable of being changed by the threshold control signals.

15. The transceiving network controller of claim 13, wherein each of the plurality of receiving address signals includes a maximum address capable of being changed by the threshold control signals.

16. The transceiving network controller of claim 13, wherein the transmission execution signal becomes active when the transmitting controller receives transmitted data from the system bus.

17. The transceiving network controller of claim 13, wherein the reception execution signal becomes active when the receiving controller receives received data from a lower layer.

18. A method for controlling buffer memory allocation and data flow, the buffer memory including a transmitting area and a receiving area capable of flexible memory allocation, the method comprising:
storing and outputting transmitted data in and from the buffer memory in response to at least one transmitting address signal;
storing and outputting received data in and from the buffer memory in response to at least one receiving address signal;
generating and outputting threshold control signals for increasing memory allocation of the transmitting area when a transmission execution signal becomes active and for increasing memory allocation of the receiving area when a reception execution signal becomes active;
generating a plurality of transmitting address signals having a maximum address capable of being changed by the threshold control signals; and
generating a plurality of receiving address signals having a maximum address capable of being changed by the threshold control signals.
